(19) United States
(12) Patent Application Publication
(10) Pub. No.: US 2008/0271643 A1
(43) Pub. Date: Nov. 6, 2008

(54) Waterproof Cement and Synergic Composition Used to Obtain High Waterproofing

(76) Inventor: Homero Ramirez Tobias, Monterey (MX)

Correspondence Address: BLANK ROME LLP, 600 NEW HAMPSHIRE AVENUE, N.W., WASHINGTON, DC, 20037, US

(21) Appl. No.: 11/720,508

(22) PCT Filed: Nov. 30, 2005
(86) PCT No.: PCT/IB05/03599

§ 371 Date: Mar. 11, 2008

(30) Foreign Application Priority Data
Nov. 30, 2004 (MX) PA/A/2004/011979

(51) Int. Cl. C04B 24/00; C04B 28/14; C04B 14/06; C04B 24/08; C04B 24/12; C04B 24/18; C04B 24/04

(52) U.S. Cl. 106/666; 106/772; 106/638; 106/817; 106/808; 106/809; 106/810; 106/802; 106/661

(57) ABSTRACT

A waterproof cements mortar or concrete compound is described. The waterproof compound contains a synergically effective quantity of a composition of water repelling and water reducing agents that are added to the waterproof compound as it is manufactured. Also described are synergic compositions for waterproofing and manufacturing methods for producing said waterproof compounds.

### FIELD OF THE INVENTION

This invention is generally related to cement compositions and more specifically is related to a waterproof cement and a synergic composition that confers high waterproofing characteristics.

### BACKGROUND OF THE INVENTION

Consumers generally seek a cement that presents the following properties: good early resistance, quick setting, good adherence, usability or workability and a fine texture. Currently, a quality that is greatly sought after by the consumer and the construction industry is that, apart from presenting the above properties, it is waterproof.

A number of compounds and methods have been developed that aim to absorb the water in compositions and cement-based products that can be classified in a general manner into: 1) water repelling additives that create a hydrophobic blocking effect that modifies surface stresses and the soaking effect on the concrete surface; ii) finely divided materials that create a physical block by filling pores; iii) finely divided solid chemical reactives that lower porosity by densifying mortar and/or concrete mixes and possibly end up reacting with the cement's hydrating compounds; iv) water reducing additives that lower porosity by reducing the quantity of water required for the concrete mix; v) use of polymeric compounds that form covering films on the surface of the concrete.

Examples of additives for concrete/mortar and methods for reducing water absorption in compositions and cement-based products that are state of the art are described below. U.S. Pat. No. 4,762,867, entitled “Cement and concrete mortar with a reduced water absorption” awarded on 9 Aug. 1988 to Polyrand AB, published a polymer-based sealing additive for porous materials such as mortar and concrete, which is mixed with the cement, water and aggregates during the preparation of the concrete or mortar mix. The inclusion of this additive in the concrete or mortar mix results in elements of lower water absorption, although its use causes problems for the concrete's late resistance, especially in cold or humid environments and in marine applications. The polymeric particles in the sealing additive contain a hydrophobic component in which the tiny hydrophobic polymer particles accumulate in the walls of capillarities and pores to establish capillarity and porosity systems that end up lowering water absorption.

U.S. Pat. No. 6,652,643, entitled “Composition and process for improving the resistance to water penetration of cementing products and cementing products based on the same” awarded on 25 Nov. 2003 to Great Barrier Technologies Inc., describes a watery emulsion of bitumen or a waxy substance added to cementing products (cement) and aggregates as a water substitute or as the watery ingredient at the time the concrete/mortar is mixed in order to improve the resistance to water penetration of products like concrete, mortar, paving, breeze blocks, etc. Preferably, this composition includes a surface-active agent to stabilise the watery emulsion.

U.S. Pat. No. 4,878,948 describes a cementing composition composed of cement, aggregates, water, a water-soluble polymer and a polyethylene glycol ester of a fatty acid that acts like a water-resistant additive.

U.S. Pat. No. 6,800,679 entitled “Durable water repellent and coated articles” is related to a composition that forms a coating film for concrete, wood, fabric (and in general any porous surface) based on a repellent that contains a perfluoro-alkaline group and a resin that contains fluoride, which provides lasting waterproofing characteristics.

U.S. Pat. No. 5,069,822 entitled “Protective coating for reinforced concrete” is related to a liquid composition of elastomeric polymers that forms a protective membrane with good conductivity performance to prevent the reinforcing steel in the concrete corroding.

U.S. Pat. No. 4,894,405 entitled “Waterproofing composition for concrete and building materials” is related to a penetrating coating composition formed by a polyurethane component and an organosilane and/or organosiloxane component. The main objective of this penetrating coating is to stop deterioration and corrosion generated by chloride ions originating from saline solutions and scaling. The coating is a waterproof compound that protects the porous surface of the concrete and other building material surfaces, penetrating into pores to create a polyurethane film.

Other compounds or compositions used as additives to impregnate, seal or coat concrete in order to waterproof or increase resistance to water penetration are published in U.S. Pat. Nos. 3,772,065; 3,819,400; 3,879,206; 3,980,597; 3,994,735; 4,442,245; 4,567,230 and 5,346,943, which are included here for reference purposes. Furthermore,

There are concrete additives that consist of a fluid, watery mixture of multiple components that are added to the fresh concrete or mortar to improve certain properties or attributes when compared to either a conventional mortar or a conventional concrete. An example of this type of fluid, watery mixture of watery components is described in U.S. Pat. No. 5,843,216, in which a fluid, watery mixture includes a loading agent (for example, a pozzolanic substance such as silicate fumes) and a stabilising agent selected from conventional concrete or wide-range water reducing agents that provide improved plasticity and workability. Another example of a mixture of multiple components is described in U.S. Pat. No. 6,436,184, in which a hydrating modifying agent that combines with a Portland-type cement produces a modified microstructure that does not lead to significant swelling during setting and limits the contraction during drying of the mortar or concrete cementing matrix. The agent that modifies the humidity contains, in combination, calcium sulphate, copolymer of ethylene/propylene oxide and a copolymer activator. Also, a colloid solution of silica and a water reducing agent such as polycarboxilate to improve the composition's fluidity is known of from the application for United States of America patent Series no. 2002/0014187.

In general, published, state of the art compounds and methods used to reduce water absorption use chemical compounds, polymers and pore-filling techniques in cement-based products, which are typically added as additives or as a mixture of additives for making concrete or mortar, applied as a coating or impregnated on the surface of the concrete and set to form a waterproof barrier, or else use polymers embedded within the concrete matrix.

However, no waterproof cement exists that is not a coating, that does not work by means of polymers and that is not an additive that is added to the cement during the mortar or concrete mixing process. Moreover, there is no synergic composition of water repelling and water reducing compounds that provides high waterproofing for building materials. Therefore, there is a technical need for a completely new waterproof cement and a manufacturing method that includes a completely new synergic composition of chemical agents. The synergic composition of chemical agents consists of water repellents and reducers that are incorporated during the cement manufacturing process, either in the clinker grinding stage or by means of a homogenising process, keeping cement properties comparable but with high waterproofing.

Therefore, one of the objects of this invention is a waterproof cement composition that contains a synergic combination of water repelling and water reducing chemical agents that forms part of it during the said cement's manufacturing process.

Another object of this invention is a synergic composition of water repelling and water reducing chemical agents to produce a waterproof cement for use in the making of concrete or mortar.

Yet another object of this invention is to provide a waterproof cement that presents these qualities: good resistance, quick setting, good adherence, usability or workability and a fine texture.

And another object of this invention is to provide a method for making a waterproof cement that contains the synergic composition of water repelling and water reducing chemical agents.

### BRIEF DESCRIPTION OF THE INVENTION

This invention describes a synergic composition of water repelling and water reducing chemical agents as a component during cement production to provide a waterproof cement that reduces water absorption by at least 80% in comparison to conventional cement. This invention also describes a cement that contains the said synergic composition of water repelling and water reducing chemical agents and a method for making a waterproof cement, in which the water repelling and water reducing agents can be incorporated at the clinker grinding stage or by means of a homogenising process that mixes them with the clinker, chalk and other aggregates. Optionally, the synergic composition of water repelling and water reducing chemical agents can be used in mortar and concrete mixes to obtain high waterproofing of the same.

Other objects, advantages and completely new aspects of the invention will become clear in the following detailed description together with the accompanying drawings.

### BRIEF DESCRIPTION OF THE DRAWINGS

The aspects considered characteristic of this invention will be set out specifically in the claims in annex. However, the invention itself, due both to its organisation and its operating method, together with other objects and advantages of the same, will be better understood in the following description when read in relation to the accompanying drawings, in which:

FIG. 1 is a graph that shows the percentage of resistance to compression of the tests, which were carried out according to the ASTM-C-109 testing method.

FIG. 2 is a graph that shows the percentage reduction of water absorption of the tests, which were carried out according to the ASTM-C-1403 testing method.

FIGS. 3A and 3F are photographs that illustrate the waterproofing effect of the different cement samples tested according to the ASTM-C-1403 testing method applied over a time period of one hour up to the 15^{th} day of water absorption.

### DETAILED DESCRIPTION OF THE INVENTION

This invention is related to a synergic composition as a component of cement, which includes water repelling agents and water reducing agents. This invention is also related to a waterproof cement and a method for making the waterproof cement, in which the synergic composition of water repelling and water reducing agents is integrated at the clinker grinding stage or by means of a homogenising process that mixes them with the clinker, chalk and other aggregates. Optionally, the synergic composition of water repelling and water reducing chemical agents can be used in mortar and concrete mixes to obtain high waterproofing of the same.

As used in this invention, the term “synergic composition” means the combination of water repelling and water reducing agents in a proportion of between 0.01% and 5% by weight of the weight of the Portland cement. The term “synergically effective quantity” is the one that provides the water repelling and water reducing effects achieving high, lasting waterproofing in the end product.

According to this invention, a composition of a water repelling agent and a water reducing agent is incorporated as a component during the manufacture of a Portland-type cement to produce a waterproof cement. The composition of water repelling and water reducing agents is highly advantageous when compared with the conventional practice of adding the water reducing and/or water repelling agent individually or separately as additives to the cement or during mixing of the concrete. Such practices do not provide the high waterproofing characteristics provided by this invention's synergic composition.

Although the mechanism of the water repelling agent and water reducing agent composition incorporated as one more component during the manufacture of a cement is not fully understood, it gives a synergic effect as proved by means of the conventional test on the reduction of water absorption in a sample of waterproof cement.

It is thought that as the cement starts to harden, the aggregate containing a water repelling additive such as, for example, a stearate, forms a water-repellent barrier, effectively preventing the migration of humidity through the cement. However, it has been shown that the use of metal stearates (for example, aluminium, calcium, cobalt, lithium, lead and zinc) as water repelling additives is not effective and fails to provide the high waterproofing characteristics sought for cement compositions.

The water reducing agents are well-known additives used in concrete making. Typically, water reducing additives are also known as “plastifiers” or “super plastifiers” and are chemical compounds, which, when added to concrete, fluidify it for a period of time in order either that (1) normal workability can be obtained in a concrete that has a far lower water to cement ratio than that normally used, or that (2) an extremely workable, fluid concrete can be obtained without undesirable side effects, or a combination of the two. A reduction of the water to cement ratio normally results in an increase in the strength of the concrete.

Examples of water repelling additives known in the trade include: stearic acid, its salts and derivatives; oleic acid, its salts and derivatives; silica gel sold under the trademark Silka 1®, and dispersions of stearate and other water repelling additives sold under the trademark Darapel®. Any person who is knowledgeable on the subject would acknowledge that the aforementioned compounds and formulas are examples and are not intended to limit this invention to the exclusive use of the same.

Examples of commercially available water reducing additives include the following classes: (1) lignosulphonic acid, its salts and derivatives; (2) melamine and its derivatives; (3) naphthalene and its derivatives; and (4) carboxilates and their derivatives. Examples of the above classes are those sold under the trademarks Disal®, Daracem 19®, Melment F10®, Glenium®, Dominol 490®. Any person who is knowledgeable on the subject would acknowledge that the aforementioned compounds and formulas are examples and are not intended to limit this invention to the exclusive use of the same.

The integration of this synergic composition of chemical agents for the production of waterproof cement is carried out by means of a manufacturing method that includes these stages: a) provision of a source of Portland cement clinker; (b) provision of a source of chalk; c) provision of aggregates; (d) provision of a synergic composition of water repelling and water reducing agents; (e) grinding of the components a) and d) in a grinding system until the appropriate fineness and grading is achieved in accordance with conventional standards. Optionally, components a) and d) are initially ground separately to then be added in dosed quantities to finally be mixed or homogenised.

In an alternative, non-preferred method, this invention's synergic composition can be formulated separately and be dosed in a synergically effective quantity to the mortar and concrete mix.

Below, non-limiting Examples are given to illustrate this invention.

### EXAMPLE 1

A composition of waterproof Portland cement was mixed, which includes the following components in the given quantities:

| | |
|---|---|
| Clinker cement | 84.25% |
| Chalk | 5.00% |
| Limestone | 10.00% |
| Synergic composition | 0.75% |

This composition was first prepared by supplying the clinker, chalk and limestone, then adding the desired quantity of the synergic composition and finally grinding together all the components in a grinding system until the appropriate fineness and grading was achieved. Optionally, all the components can initially be ground separately to then be added in dosed quantities, finally to be mixed or homogenised.

### EXAMPLE 2

A composition of waterproof Portland cement was prepared, which contains the following components in the given quantities:

| | |
|---|---|
| Cement clinker | 74.25% |
| Chalk | 5.00% |
| Limestone | 5.00% |
| Pozzolan | 15.00% |
| Synergic composition | 0.75% |

### EXAMPLE 3

A composition of waterproof Portland cement was prepared, which contains the following components in the given quantities:

| | |
|---|---|
| Cement clinker | 94.25% |
| Chalk | 5.00% |
| Synergic composition | 0.75% |

The compositions of Examples 2 and 3 were prepared substantially in the same way as the composition of Example 1.

The invention will also be described with reference to the experimental results illustrated in the drawings.

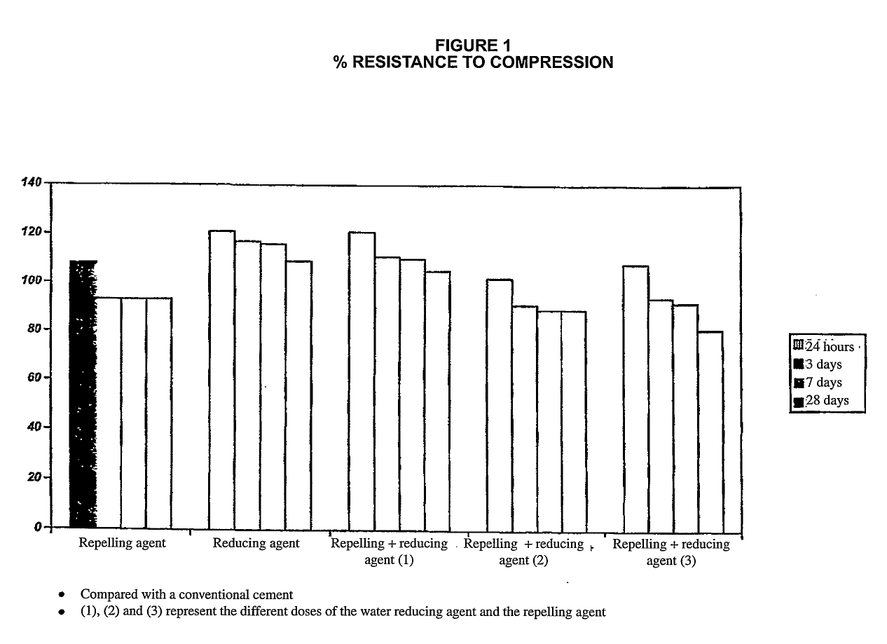

With reference to FIG. 1, this shows in graphic form the result of the percentage of resistance on the compression carried out on different cement samples compared to a conventional Portland cement. These five samples consist of (1) a cement that incorporates a water repelling agent, (2) a cement that incorporates a water reducing agent, (3,4,5) a cement that incorporates one of this invention's synergic compositions of water repelling and water reducing agents at various doses.

To carry out the resistance to compression test, cement samples were prepared according to the ASTM-C-109 testing method for a conventional Portland cement composition and the following cement compositions:

a) Portland cement modified with the incorporation of 0.01% to 5% by weight of water repelling agent based on the total cement weight;
b) Portland cement modified with the incorporation of 0.01% to 5% by weight of water reducing agent based on the total cement weight;
c) three samples of this invention's waterproof Portland cement, each with the incorporation of different doses of the synergic composition of water repelling and water reducing agents, contained within the range of 0.01% to 5% of the total cement weight.

The results obtained in the resistance to compression Test for the above samples are shown in Table 1 below:

TABLE 1
Resistance Test Results compared to
Conventional Cement (%)

| | 24 | 3 | 7 | 28 |
|---|---|---|---|---|
| Conventional Portland Cement+: | hours | days | days | days |
| Water Repelling Agent | 108 | 93 | 93 | 93 |
| Water Reducing Agent | 121 | 117 | 116 | 109 |
| Reducing Agent + Repelling Agent (1) | 121 | 111 | 110 | 105 |
| Repelling Agent + Reducing Agent (2) | 102 | 91 | 89 | 89 |
| Repelling Agent + Reducing Agent (3) | 108 | 94 | 92 | 81 |

*The base resistance of Conventional Portland Cement is understood to be 100.

As can be observed from the results of Table 1, the resistance to compression of the cement samples modified with the synergic composition is not adversely affected.

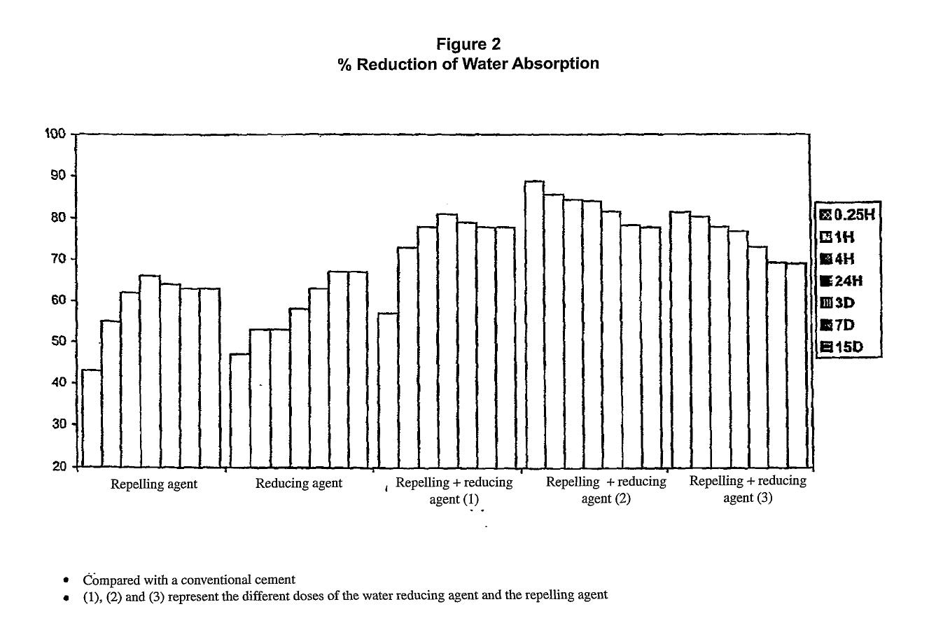

With reference to FIG. 2, this shows in graphic form the percentage reduction of water absorption with respect to the traditional cement in tests carried out on the following different cement samples:

Portland cement modified with the incorporation of 0.01% to 5% by weight of water repelling agent based on the total cement weight;
b) Portland cement modified with the incorporation of 0.01% to 5% by weight of water reducing agent based on the total cement weight;
c) three samples of this invention's waterproof Portland cement, each with the incorporation of different doses of the synergic composition of water repelling and water reducing agents, contained within the range of 0.01% to 5% of the total cement weight.

The results of the Water Absorption Reduction Test with respect to conventional Portland cement are shown below:

TABLE 2
Water Absorption Reduction Test Results with
respect to Conventional Cement (%)

| | 0.25 | 1 | 4 | 24 | 3 | 7 | 15 |
|---|---|---|---|---|---|---|---|
| | hours | hour | hours | hours | days | days | days |
| Repelling Agent | 43 | 55 | 62 | 66 | 64 | 63 | 63 |
| Reducing Agent | 47 | 53 | 53 | 58 | 63 | 67 | 67 |
| Repelling + Reducing | 57 | 73 | 78 | 81 | 79 | 78 | 78 |
| Agents (1) | | | | | | | |
| Repelling and | 89 | 86 | 85 | 84 | 82 | 78 | 78 |
| Reducing Agents (2) | | | | | | | |
| Repelling and | 81 | 80 | 78 | 77 | 73 | 69 | 69 |
| Reducing Agents (3) | | | | | | | |

From the above results we can conclude that with the inclusion of this invention's synergic composition a surprisingly high reduction of water absorption is obtained, giving the cement produced high waterproofing characteristics.

It can also be observed that the synergic composition produces a reduction of water absorption superior to that obtained by the water repelling agent or water reducing agent on its own.

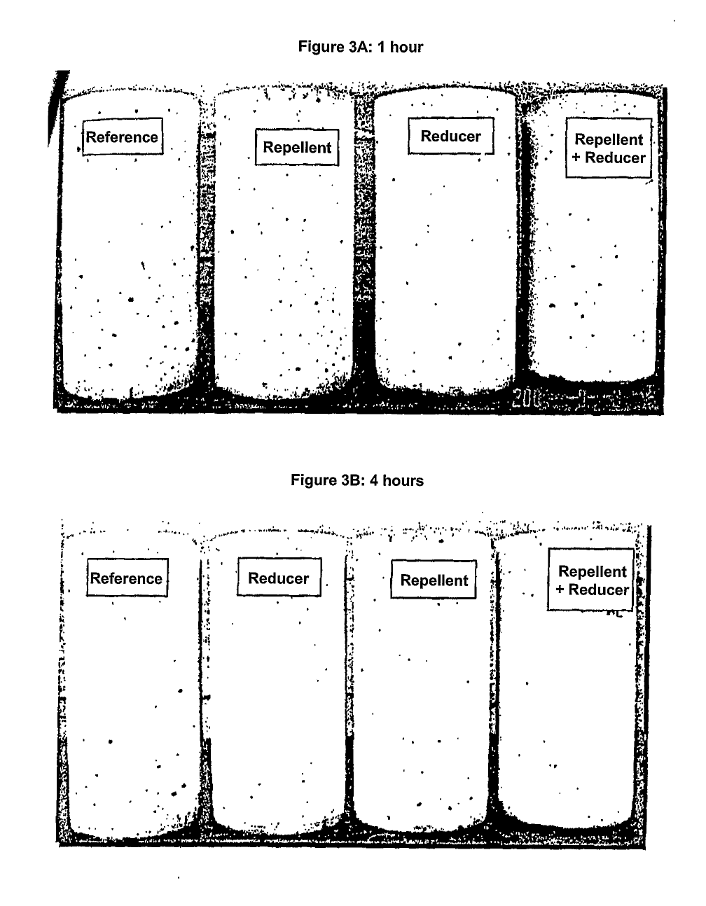

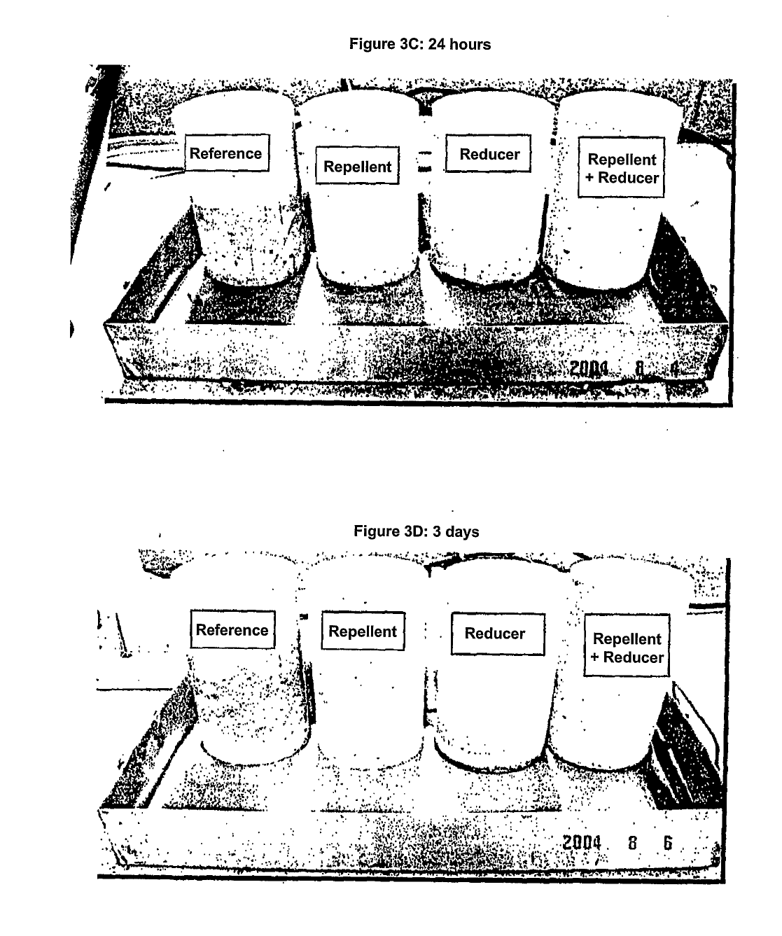

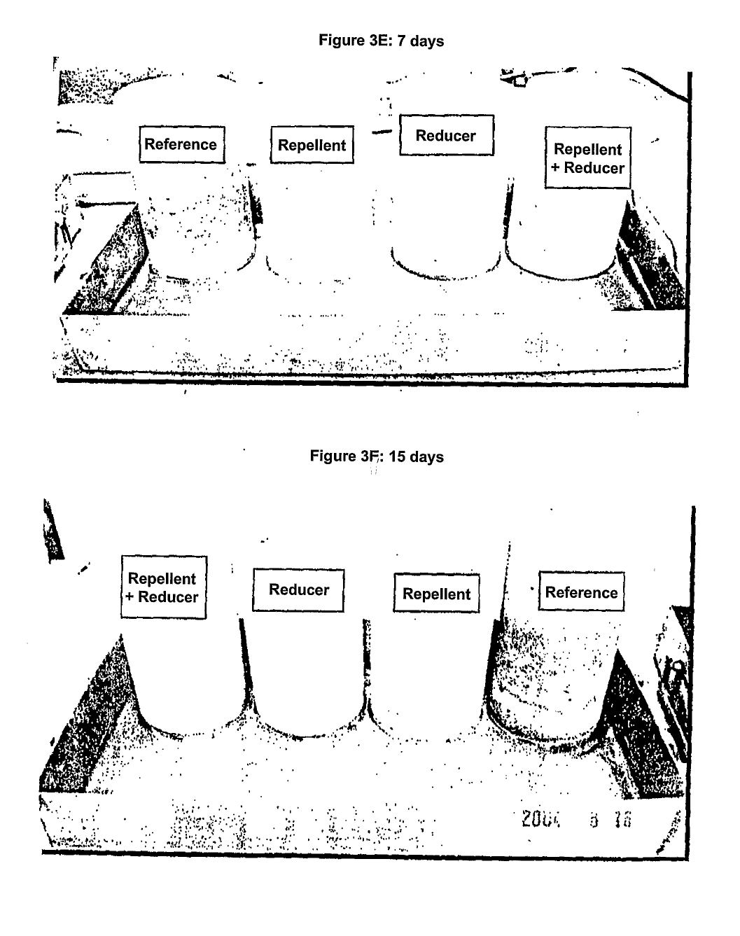

FIGS. 3A to 3F illustrate the waterproofing effect of the different cement samples tested according to the ASTM-C-1403 testing method, subject to exposure to water during a water absorption period of 1 hour, 4 hours, 24 hours, 3 days, 7 days and 15 days. The photographs corroborate the pronounced and surprising water absorption reduction effect that can be better appreciated in FIGS. 3C to 3F, which correspond to periods of exposure to water of 24 hours, 3 days, 7 days and 15 days, respectively.

Now that certain of the invention's modalities have been illustrated and described, we should underline that many modifications of these are possible. This invention, therefore, should be considered to be restricted only by the requirements of the above technique and by the nature of the claims in annex.

1. A waterproof cement that reduces water absorption comprising:
a) cement clinker;
b) gypsum; and
c) a synergically effective quantity of a water repelling and water reducing composition.

2. A waterproof mortar comprising:
a) cement;
b) sand; and
c) a synergically effective quantity of a water repelling and water reducing composition.

3. A waterproof concrete comprising:
a) cement;
b) sand;
c) gravel;
d) water; and
e) a synergically effective quantity of a composition of water repelling and water reducing agents.

4. The waterproof cement, mortar or concrete according to claim 1, wherein the water repelling and water reducing agents are incorporated during the said cement's manufacturing process.

5. The waterproof cement, mortar or concrete according to claim 1, wherein the cement can also contain aggregates.

6. The waterproof cement, mortar or concrete according to claim 1, wherein the water repelling and water reducing agents are present at a concentration between 0.01% and 5% by weight of cement.

7. The waterproof cement, mortar or concrete according to claim 1, wherein the water repellent can be selected from the group consisting of stearic acid, its salts and derivatives, oleic acid, its salts and derivatives, silica gel and dispersions of stearate.

8. The waterproof cement, mortar or concrete according to claim 1, wherein the water repellent can be selected from the group consisting of lignosulphonic acid, its salts and derivatives, melamine and its derivatives, naphthalene and its derivatives and carboxylates and their derivatives.

9. A synergic composition for adding to cement providing high reduction of water absorption that confers waterproofing to the cement and its end products, the synergic composition comprising a water repelling agent and a water reducing agent.

10. The synergic composition according to claim 9, wherein the water repellents and water reducers are present at a concentration between 0.01% and 5% by weight of cement.

11. The synergic composition according to claim 9, wherein the water repelling agent can be selected from the group consisting of stearic acid, its salts and derivatives, oleic acid, its salts and derivatives, silica gel and dispersions of stearate.

12. The synergic composition according to claim 9, wherein the water reducing agent can be selected from the group consisting of lignosulphonic acid, its salts and derivatives, melamine, and its derivatives, naphthalene and its derivatives and carboxylates and their derivatives.

13. A method for making waterproof cement comprising:
a) providing a source of cement clinker;
b) providing a source of gypsum;
c) providing a synergic composition of water repelling and water reducing agents; and
d) grinding components a) through c) in a grinding system until the appropriate fineness and grading are achieved.

14. A method for manufacturing a waterproof mortar comprising:
a) providing a source of sand;
b) providing a source of cement comprising a synergically effective composition of water repelling and reducing agents; and
c) mixing components a) and b).

15. A method for manufacturing a waterproof concrete comprising:
a) providing a source of sand;
b) providing a source of gravel;
c) providing a source of water;
d) providing a source of cement comprising a synergically effective quantity of water repelling and water reducing agents; and
e) mixing components a) through d).

16. The method according to claim 13, wherein components a) to c) are initially ground separately and added in dosed quantities to be finally mixed or homogenised.

17. The method according to claim 13, further comprising step (e) adding aggregates to the ground mixture.

18. The method according to claims 13, wherein the water repelling and water reducing agents are present in a concentration between 0.01% and 5% by weight of cement.

19. The method according to claims 13, wherein the water repelling agent can be selected from the group consisting of stearic acid, its salts and derivatives, oleic acid, its salts and derivatives, silica gel and dispersions of stearate.

20. The method according to claims 13, wherein the water reducing agent can be selected from the group consisting of lignosulphonic acid, its salts and derivatives, melamine, and its derivatives, naphthalene and its derivatives and carboxylates and their derivatives.
